(19) United States
(12) Patent Application Publication
(10) Pub. No.: US 2025/0238091 A1
(43) Pub. Date: Jul. 24, 2025

(54) REFERENCE FRAME ALIGNMENT BETWEEN COMPUTING DEVICES

(71) Applicant: Google LLC, Mountain View, CA (US)

(72) Inventors: Mar Gonzalez Franco, Seattle, WA (US); Eric Jordan Gonzalez, Seattle, WA (US); Karan Ahuja, Seattle, WA (US); Andrea Colaco, Los Altos, CA (US)

(21) Appl. No.: 19/035,552

(22) Filed: Jan. 23, 2025

Related U.S. Application Data
(63) Continuation of application No. 63/624,200, filed on Jan. 23, 2024.

(51) Int. Cl. G06F 3/038; G06F 3/0354; G06T 7/70

(52) U.S. Cl. CPC G06F 3/038; G06F 3/03547; G06T 7/70; G06T 2207/30196

(57) ABSTRACT

A method performed by a first computing device comprises determining an orientation of a body portion using a camera on the first computing device; presenting, on a display, a representation of the body portion and a representation of an alignment position for a second computing device; while the second computing device is in the alignment position, receiving a communication from the second computing device, the communication including orientation data; and determining a calibration parameter based on the orientation data and the orientation of the body portion.

### CROSS-REFERENCE TO RELATED APPLICATION

This application claims priority to U.S. Provisional Patent Application No. 63/624,200, filed on Jan. 23, 2024, entitled “REFERENCE FRAME ALIGNMENT BETWEEN COMPUTING DEVICES,” the disclosure of which is incorporated by reference herein in its entirety.

### BACKGROUND

An extended reality (XR) device incorporates a spectrum of technologies that blend physical and virtual worlds, including virtual reality (VR), augmented reality (AR), and mixed reality (MR). These devices immerse users in digital environments, either by blocking out the real world (VR), overlaying digital content onto the real world (AR), or blending digital and physical elements seamlessly (MR). XR devices that include headsets, glasses, or screens equipped with sensors, cameras, and displays that track movement of users and surroundings to deliver immersive experiences across various applications such as gaming, education, healthcare, on-the-go computing, and industrial training.

### SUMMARY

Implementations relate to using on-device cameras and natural interactions between a companion device (e.g., mobile, wearable, or handheld device) and an immersive device (e.g., XR device or head-mounted device) to achieve frame alignment and account for drift over time. This enables multi-device interactions in the three-dimensional (3D) space without fiducial markers or generating computationally costly maps on each device. In at least one example, each device may gain a world reference independently and then align/re-align with each other using a body part or body portion (e.g., hands, head, or other extremity) that is being tracked by one of the devices (body tracking) as the common frame of reference. In some implementations, a first computing device, such as a head-mounted device, can guide a user to position a second computing device, such as a mobile device, to an alignment position (e.g., aligning the user's thumb and index finger with the edges of the mobile device). Once in the alignment position, the first computing device can calibrate or align a common reference frame for the first computing device with the second computing device. A common frame of reference can establish a shared coordinate system or spatial understanding that allows them to align their positions, orientations, and movements relative to each other and the environment. In some implementations, the first computing device can continue to capture the user's hand movements (via an outward-facing camera or other sensor). The first computing device can use the imaging information to refine and enhance the alignment of the second computing device relative to the first computing device.

In some aspects, the techniques described herein relate to a method performed by a first computing device, the method including: determining an orientation of a body portion using a camera on the first computing device; presenting, on a display, a representation of an alignment position for a second computing device relative to the body portion; receiving a communication from the second computing device, the communication including orientation data for the second computing device in the alignment position; and determining a calibration parameter based on the orientation data and the orientation of the body portion, the calibration parameter used to establish a common coordinate system between the first computing device and the second computing device.

In some aspects, the techniques described herein relate to a computing system including: a computer-readable storage medium; at least one processor operatively coupled to the computer-readable storage medium; and program instructions stored on the computer-readable storage medium that, when executed by the at least one processor, direct the computing system to perform a method for a first computing device, the method including: determining an orientation of a body portion using a camera on the first computing device; presenting, on a display, a representation of an alignment position for a second computing device relative to the body portion; receiving a communication from the second computing device, the communication including orientation data for the second computing device in the alignment position; and determining a calibration parameter based on the orientation data and the orientation of the body portion, the calibration parameter used to establish a common coordinate system between the first computing device and the second computing device.

In some aspects, the techniques described herein relate to a computer-readable storage medium having program instructions stored thereon that, when executed by at least one processor, direct the at least one processor to perform a method of operating a first computing device, the method including: determining an orientation of a body portion using a camera on the first computing device; receiving a communication from a second computing device, the communication including orientation data for the second computing device at a time the body portion is in the orientation; and determining a calibration parameter based on the orientation data and the orientation of the body portion, the calibration parameter used to establish a common coordinate system between the first computing device and the second computing device.

The details of one or more implementations are set forth in the accompanying drawings and the description below. Other features will be apparent from the description and drawings, as well as from the claims.

### BRIEF DESCRIPTION OF THE DRAWINGS

FIG. 1A shows a user holding a mobile device while wearing a head-mounted device.

FIG. 1B shows an image, captured by the head-mounted device, of the hand of the user holding the mobile device.

FIG. 2A shows the user holding the mobile device in an alignment position.

FIG. 2B shows an image, captured by the head-mounted device, of the hand of the user holding the mobile device in the alignment position.

FIG. 3 shows the user holding the mobile device in preparation to make a throwing motion.

FIG. 4 shows the user holding the mobile device after making the throwing motion.

FIG. 5 is an image presented by the head-mounted device showing the hand of the user holding an object.

FIG. 6 is an image presented by the head-mounted device showing the hand of the user holding an object and writing on a whiteboard with the object.

FIG. 7A is an operational scenario of using imaging from a wearable or immersive device to align reference frames with a second device.

FIG. 7B is an operational scenario of using imaging from a handheld device to determine a common frame of reference with a wearable or immersive device.

FIG. 8 shows an architecture for aligning one or more devices.

FIG. 9 is a block diagram of a computing system that can implement techniques described herein.

FIG. 10 is a flowchart showing a method performed by a computing device.

Like reference numbers refer to like elements.

### DETAILED DESCRIPTION

Computing devices, such as immersive devices (including head-mounted devices) and mobile devices (including smartphones and wearables, such as smart watches), can interact. For example, a user can move a mobile device or interact with the mobile device to prompt an action by an immersive device (e.g., XR device). However, to interact inside a three-dimensional (3D) space, the devices need a common reference frame so that the non-immersive device (the mobile device) can be rendered correctly by the immersive device. This common reference frame can be referred to as alignment, spatial tracking, or spatial synchronization. At least one technical problem with supporting interactions between head-mounted and mobile devices inside a 3D space is achieving alignment between the devices. While these computing devices can separately create maps (e.g., simultaneous localization and mapping (SLAM) achieved maps) that are shared and used for alignment, this approach is computationally costly, which can drain the battery on each device and is slow. Further, fiducial markers (e.g., QR codes, April tags) can be used but are obtrusive. The fiducial marker may be only partially visible, inhibiting the visual processing and, thus, alignment. Such a method can also fail to account for drift.

At least one technical solution to the technical problem of achieving alignment between computing devices, a first computing device can perform alignment with a second computing device based on a body portion of the user. The alignment can be achieved by a calibration process that determines the relative orientations of the computing devices. A computing device, such as a head-mounted computing device, can prompt a user to place another device, such as a mobile device, in an alignment position. The alignment position can be a predetermined position associated with a portion of the user's body. An example of an alignment position is placing a corner of the mobile device in a corner of an L-shape formed by the thumb and forefinger of the user. The computing device can determine the orientation of the body portion (such as thumb and forefinger) based on one or more images captured by the computing device. In some implementations, the computing device can be designed to track the motion of the user in within the 3D environment. It can use data from cameras, depth sensors, or other sensors to map and localize the body's position and posture relative to its surroundings. The computing device can also receive orientation data from the other computing device.

After the user places the other computing device (such as the mobile device) in the alignment position and the computing device receives the orientation data, the computing device can align and/or calibrate the common frame of reference between the two devices. In some implementations, the alignment enables the computing device to interpret spatial data consistently in association with the other device (i.e., a shared coordinate system). In some examples, this allows for accurate alignment of virtual and physical objects, ensuring interactions, such as augmented reality overlays or synchronized movements, appear seamless. The computing device can use the understanding to provide an immersive experience for the user. In some implementations, the computing device can continue to determine the orientations and locations of a user's hand when the user interacts with the device (e.g., provides touch input) and can update the calibration parameter associated with the alignment based on the touch. For example, the immersive device can capture the user's hand's location (and orientation) when the handheld device registers a touch. From the touch location provided by the handheld device and the identified orientation of the user's hand, the alignment can be updated.

Although demonstrated in the previous example of using the immersive device to track the handheld device, similar operations can be performed by the handheld device to maintain a common reference frame with the immersive device. In at least one implementation, the handheld device can use one or more cameras (e.g., an inward-facing camera) to monitor the user's head movements. In some examples, the handheld device can also use a second camera (e.g., an outward-facing camera) to identify the world or environment location associated with the handheld device. The device can use the imaging information to align the frames associated with the handheld device and the immersive device. As a technical effect, a common reference frame can be determined by the handheld device using imaging information captured of the immersive device.

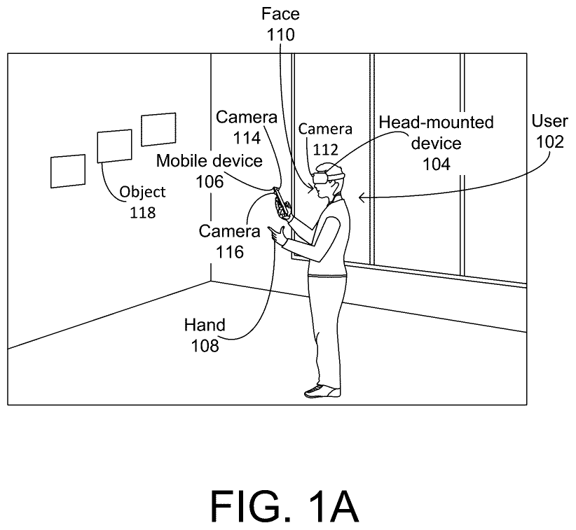

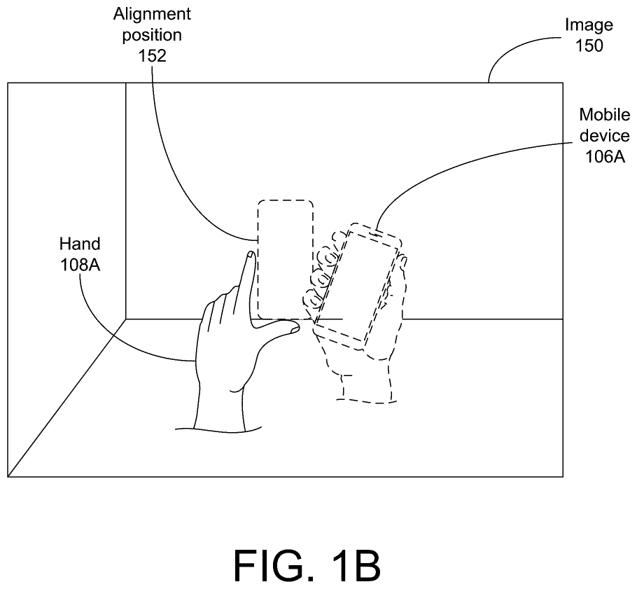

FIG. 1A shows a user 102 holding a mobile device 106 while wearing a head-mounted device 104. The head-mounted device 104 can present a virtual and/or augmented reality environment to the user 102. The head-mounted device 104 can present a virtual and/or augmented reality environment to the user 102 by presenting objects to the user 102 via a display. The head-mounted device 104 can include one or more cameras, such as a front-facing camera 112, that capture images of the mobile device 106, a hand 108 of the user 102, and/or a surrounding environment.

The mobile device 106 can capture images of the user 102 and the surrounding environment via multiple cameras. In some examples, a first camera 114 (i.e., a front-facing camera) can face the user 102 and capture images of a body portion such as the face 110 of the user 102. In some examples, a second camera 116, which can be on the opposite side of the mobile device 106 from the first camera and can be considered a rear-facing camera, can capture images of at least one object 118 and/or an environment on an opposite side of the mobile device 106, such as the user 102. The mobile device 106 can then determine the location of the mobile device 106 within the world based on identifying objects within the images captured by the cameras. The location of the mobile device 106 can be considered a device location.

The head-mounted device 104 can determine the location of the hand 108 holding the mobile device 106 based on an image recognition library and/or application. The hand 108 is an example of a body portion. The location of the hand 108 can be considered a body portion location. An orientation of the hand can be regarded as a body portion orientation. The head-mounted device 104 may have difficulty determining the location and/or orientation of the mobile device 106. The head-mounted device 104 may be more accurate and/or efficient at locating and determining an orientation of a body portion, such as the hand 108, than at locating and determining the orientation of the mobile device 106. The head-mounted device 104 can instruct the user 102 to form a predetermined gesture with a body portion, such as an L-shape with thumb and forefinger of the hand 108. In some examples, the head-mounted device 104 presents an icon representing the predetermined gestures. In some examples, the head-mounted device 104 outputs an audible instruction for the user 102 to form the predetermined gesture. The user 102 can form the predetermined gesture with the body portion. The head-mounted device 104 can guide and/or prompt the user 102 to place the mobile device 106 in an alignment position. In some examples, the alignment position is a predetermined location relative to the body portion (such as the hand 108). In some examples, the alignment position accurately determines the orientation of the body portion and/or the mobile device 106 by the head-mounted device 104. In the example of forming an L-shape by the thumb and forefinger, the orthogonality of the thumb to the forefinger enables accurate determination of the alignment position 152. The head-mounted device 104 can guide and/or prompt the user 102 to place the mobile device 106 in an alignment position by presenting an image with and/or in the alignment position to the user 102.

In some examples, the mobile device 106 determines the orientation of the head-mounted device 104 based on capturing an image of the face 110 of the user 102 with the first camera 114. The mobile device 106 can determine the orientation of the head-mounted device 104 relative to the mobile device 106 based on the image of the face 110 captured by the first camera 114. The mobile device 106 can receive sensor data from the head-mounted device 104 via a wireless interface. The sensor data received by the mobile device 106 from the head-mounted device 104 can indicate the orientation and/or movement of the head-mounted device 104. The received sensor data can include, for example, accelerometer data, inertial measurement unit (IMU) data, gyroscope data, orientation data, proximity data, and/or light sensor data, as non-limiting examples. In some examples, the sensor data includes a measured orientation of the mobile device 106. The mobile device 106 can determine the measured orientation based on accelerometer data, IMU data, gyroscope data, orientation data, proximity data, and/or light sensor data, as non-limiting examples. The mobile device 106 can determine a calibration parameter based on comparing the orientation of the face 110 determined by the mobile device 106 based on the image captured by the camera 114 to the orientation data received from the head-mounted device 104. The mobile device 106 can thereafter determine an orientation of the head-mounted device 104 by adjusting an orientation, determined based on recognizing the face 110 within an image captured by the camera 114, by the calibration parameter.

FIG. 1B shows an image 150, captured by the head-mounted device 104, of the hand 108 of the user 102 holding the mobile device 106. The image 150 is presented to the user 102 via a display included in the head-mounted device 104. The image 150 includes a representation of the mobile device 106A, a representation of the hand 108A, and an indication of an alignment position 152. The representation of the mobile device 106A is shown in dashed lines to indicate that in a virtual reality environment, in which the user 102 sees only what is presented on a display, the mobile device 106 may not be visible to the user 102 until the alignment of the mobile device 106 has been determined and/or the calibration parameter of the mobile device 106 has been determined. In an augmented reality environment, in which the user views the mobile device 106 through transparent lenses and the alignment position 152 is projected onto the lens for viewing by the user 102, the mobile device 106 would be visible to the user 102. The representation of the hand 108A is based on the captured image that includes the hand 108. The head-mounted device 104 adds the alignment position 152 to the image 150. The indication of the alignment position 152 can include a rectangle or other shape in a location to which the user 102 should move the mobile device 106. The indication of the alignment position 152 can also indicate an orientation into which the user 102 should move the mobile device 106. The head-mounted device 104 determines the location to which the user 102 should move the mobile device 106 based on a determination by the head-mounted device 104 of the location and orientation of the hand 108 of the user 102. The indication of the alignment position 152 is a prompt generated by the head-mounted device 104 for the user 102 to move the mobile device 106 into the alignment position 152. The head-mounted device 104 can also provide a semantic instruction for the user 102 to move the mobile device 106 into the alignment position 152, such as an audible instruction or text presented on a display presented by the head-mounted device 104.

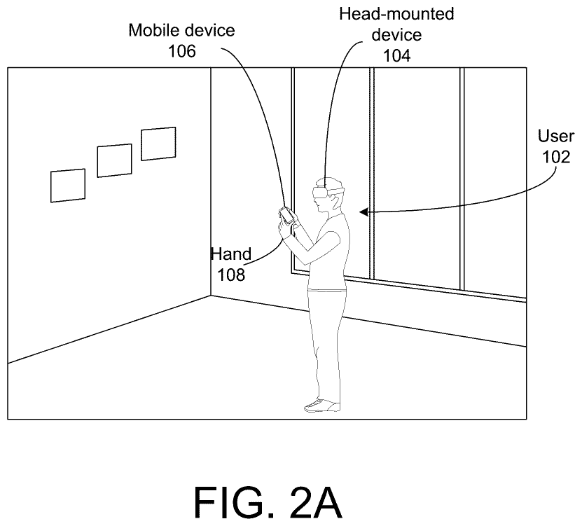

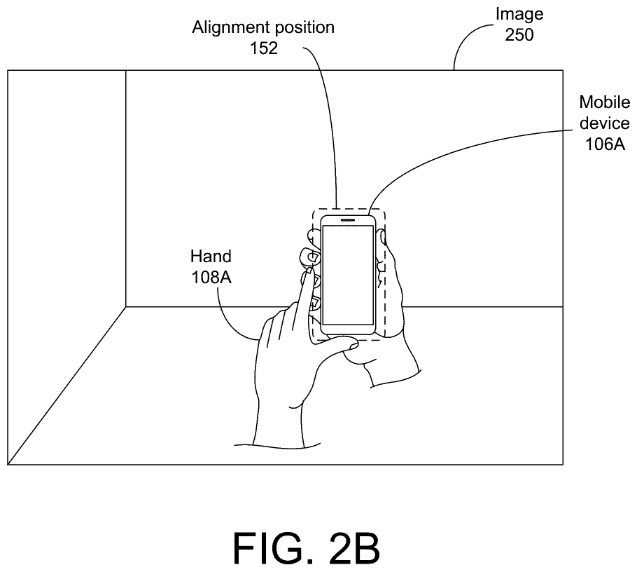

FIG. 2A shows the user 102 holding the mobile device 106 in the alignment position 152 (not labeled in FIG. 2A). The user 102 has moved the mobile device 106 into the alignment position in response to the prompt and/or presentation of the alignment position 152 by the head-mounted device 104 within the image presented by the head-mounted device. The user 102 can indicate that the user 102 has moved the mobile device 106 into the alignment position 152 by, for example, providing an oral indication of alignment or tapping on the mobile device 106 a predetermined number of times.

FIG. 2B shows an image 250, captured by the head-mounted device 104, of the hand 108 of the user 102 holding the mobile device 106 in the alignment position 152. FIG. 2B shows the representation of the hand 108A and the representation of the mobile device 106A detected using the camera 112 and hand recognition software included in the head-mounted device 104. FIG. 2B also shows the alignment position 152 aligned with the representation of the mobile device 106A. The representation of the hand 108A is a representation of the hand that forms a predetermined gesture and from which the head-mounted device determines an alignment for purposes of determining a calibration parameter. The head-mounted device 104 can generate the image 250 in a similar manner to the image 150. In the virtual reality environment, the head-mounted device can additionally generate the representation of the mobile device 106A after aligning the mobile device 106 with the hand 108.

The alignment of the mobile device 106 and/or representation of the mobile device 106A enables the head-mounted device 104 to determine a calibration parameter for the orientation measured by the mobile device 106 compared to the orientation of the hand 108. The head-mounted device 104 may have determined the orientation of the hand 108 by recognizing and/or classifying the hand 108, and/or representation of the hand 108A. In some examples, the head-mounted device 104 receives an indication from the user 102 that the mobile device 106 is in the alignment position 152, such as an audible or oral statement, selection of an input button, and/or a predetermined number of taps by the user 102 on the mobile device 106. The user 102 can determine that the mobile device 106 is in the alignment position 152 based on the alignment of the mobile device 106 with the predetermined gesture (such as the L-shape of the thumb and forefinger) of the hand 108.

The head-mounted device 104 can determine orientation of the body portion (such as thumb and forefinger of the hand 108) based on one or more images captured by the head-mounted device 104 and the body part classifier. The head-mounted device 104 can also receive orientation data, such as gyroscope measurements and/or accelerometer measurements, from the mobile device 106. After the user 102 places the mobile device 106 in the alignment position 152 and the head-mounted device 104 receives the indication that the device 106 is in the alignment position and receives the orientation data from the mobile device 106, the head-mounted device 104 can align and/or calibrate an orientation of the mobile device 106 with respect to the orientation of the head-mounted device 104. The alignment and/or calibration between the orientation of the hand 108 of the user 102 (as determined by the head-mounted device based on the image 250) and the orientation of the mobile device 106 (as determined by either or both of the mobile device 106 or the head-mounted device 104 based on sensor data measured by the mobile device 106) can include determining a calibration parameter between the orientation of the hand 108 of the user 102 and the orientation of the mobile device 106. The calibration parameter can be a difference between the orientation of the hand 108 of the user 102, as determined by the head-mounted device 104 based on the image 250, and the orientation of the mobile device 106 determined based on measurements performed by the mobile device 106. The calibration parameter can, for example, be represented in six degrees of freedom, such as a translation along three orthogonal axes and rotation along three orthogonal axes. Adding or subtracting the calibration parameter to or from the orientation of the hand 108 of the user 102 results in the orientation of the mobile device 106. Adding or subtracting the calibration parameter to or from the orientation of the mobile device 106 results in the orientation of the hand 108 of the user 102. The computing device can thereafter determine locations and orientations, including previous locations and orientations, present locations and orientations, and subsequent locations orientations, of the mobile device 106 by applying the parameter. In some implementations, applying the parameter can include adding or subtracting the calibration parameter to or from an orientation of the mobile device 106 that is determined based on movement and/or alignment measurements received from the mobile device 106.

In some implementations, the head-mounted device can continue to update the calibration parameter to refine or align the common reference frame. In at least one implementation, the immersive device can monitor touch inputs to the device and update the parameter based on the occurrence of a touch input. For example, the handheld device can register input from the user (e.g., a touch of a touchscreen) at the handheld device. In response to the input, the immersive device can determine the orientation of the user's body or portion of the user during the input and update the alignment or the common reference based on the orientation. For example, when the user provides a touch on a touchscreen of the handheld device, the immersive device can receive an indication of the touch and can receive orientation data associated with the handheld device. The orientation information can be compared to the orientation of the hand providing the touch to determine an update for the orientation parameter. In some implementations, the update can align the handheld device in the world representation maintained by the immersive device.

Although demonstrated in the previous example of using the immersive device to track the handheld device, similar operations can be performed by the handheld device to maintain a common reference frame with the immersive device. In at least one implementation, the handheld device can use one or more cameras (e.g., an inward-facing camera) to monitor the user's head movements. In some examples, the handheld device can also use a second camera (e.g., an outward-facing camera) to identify the world or environment location associated with the handheld device. The device can use the imaging information to align the frames associated with the handheld device and the immersive device. As a technical effect, a common reference frame can be determined by the handheld device using imaging information captured of the immersive device. the handheld device can compare the orientation calculated from the image to the orientation sensor data provided by the immersive device to determine a parameter that can adjust the provided sensor data to the orientation calculated from the image.

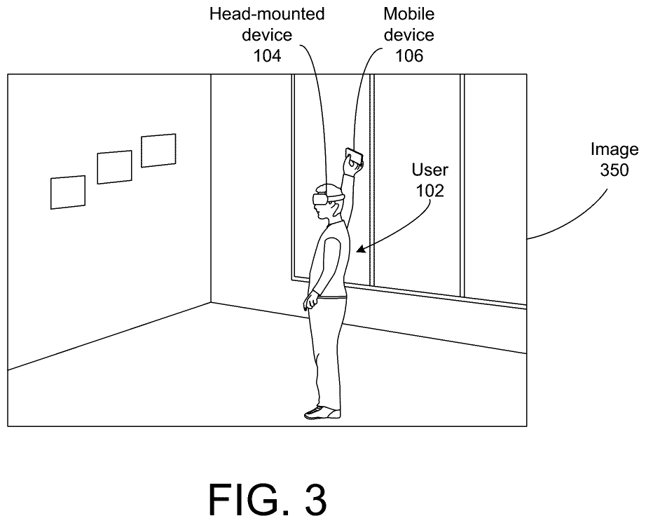

FIG. 3 shows the user 102 holding the mobile device 106 in preparation to make a throwing motion. The head-mounted device 104 can determine a present location and/or orientation of the mobile device 106 by applying the calibration parameter to a location and/or orientation of the mobile device 106 determined based on sensor measurements performed by the mobile device 106.

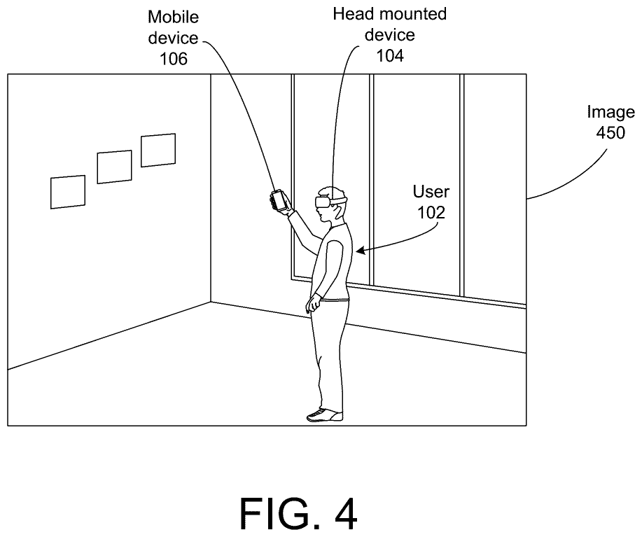

FIG. 4 shows the user 102 holding the mobile device 106 after making the throwing motion. The head-mounted device 104 can determine a location and/or orientation of the mobile device 106 by applying the calibration parameter to a location and/or orientation of the mobile device 106 determined based on sensor measurements performed by the mobile device 106.

The head-mounted device 104 can perform an action based on the determined position and/or orientation of the mobile device 106 and/or determination of motion of the mobile device 106 based on the positions determined as shown in FIGS. 3 and 4. The head-mounted device 104 can, for example, determine that the user 102 made a throwing or slashing motion with the mobile device 106.

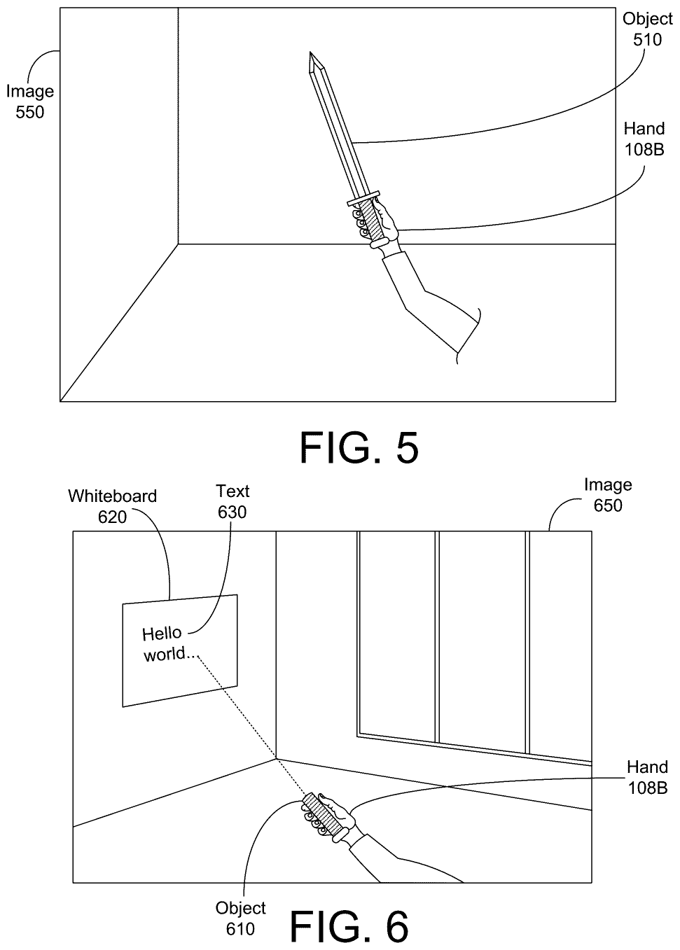

FIG. 5 is an image 550 presented by the head-mounted device 104 showing the hand 108 of the user 102 holding an object 510. The image 550 is based on an image captured by a camera included in the head-mounted device 104. The image 550 includes a representation of the hand 108B. The representation of the hand 108B can be based on the capturing of the image of the hand 108. The representation of the hand 108B can be a representation of a hand that holds the mobile device 106. The head-mounted device 104 can replace the mobile device 106 with the object 510 within the image 550. In the example shown in FIG. 5, the object 510 is a sword or dagger. The head-mounted device 104 replaced the mobile device 106 with the object 510 to generate the virtual reality environment and/or augmented reality environment for presentation to the user 102. The head-mounted device 104 placed the object 510 within the image 550 based on the determined location and/or orientation of the mobile device 106. The head-mounted device 104 determined the location and/or orientation of the mobile device 106 based on the adjusting the location and/or orientation of the mobile device 106, as determined by sensor data measured by the mobile device 106, by the calibration parameter.

FIG. 6 is an image 650 presented by the head-mounted device 104 showing the hand 108A of the user 102 holding an object 610 and writing on a whiteboard 620 with the object 610. The image 650 is based on an image captured by a camera included in the head-mounted device 104. The image 650 includes a representation of the hand 108B. The representation of the hand 108B can be based on the capturing of the image of the hand 108 by a camera included in the head-mounted device 104. The object 610 can replace the mobile device 106 within the image 650. In the example shown in FIG. 6, the object 610 is a virtual stylus or laser pointer. The head-mounted device 104 has created a whiteboard 620 for writing on by adding the whiteboard 620 to the image 650. The whiteboard 620 can be considered a virtual whiteboard that is generated by the head-mounted device 104 within a virtual reality and/or augmented reality environment.

The head-mounted device 104 determined multiple locations and/or orientations of the mobile device 106 by adjusting multiple locations and/or orientations of the mobile device 106, as determined based on sensor measurements performed by the mobile device 106, by the calibration parameter. Based on the multiple locations and/or orientations of the mobile device 106 that the head-mounted device 104 determined, the head-mounted device 104 can determine and/or recognize a gesture or gestures. In the example shown in FIG. 6, the determined and/or recognized gestures are writing gestures. The gestures correspond to letters. Based on the gestures, the head-mounted device 104 added text 630 to the whiteboard 620. The text 630 is based on the writing gestures made by the user 102 with the mobile device 106.

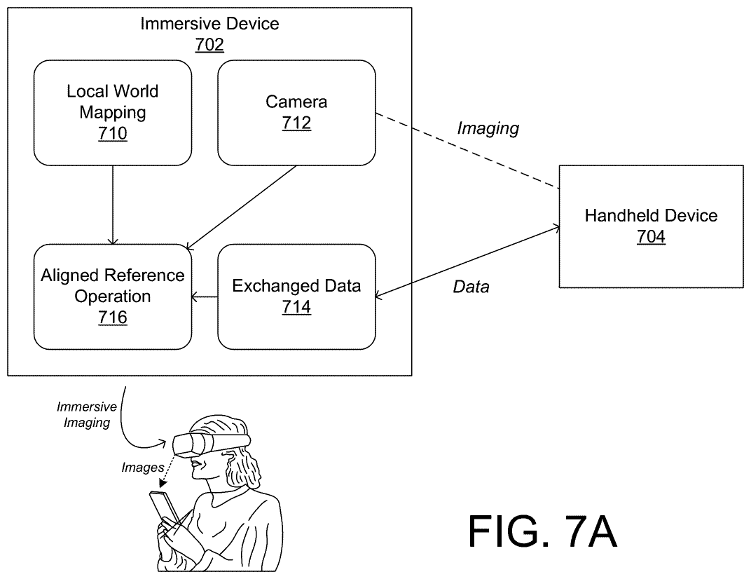

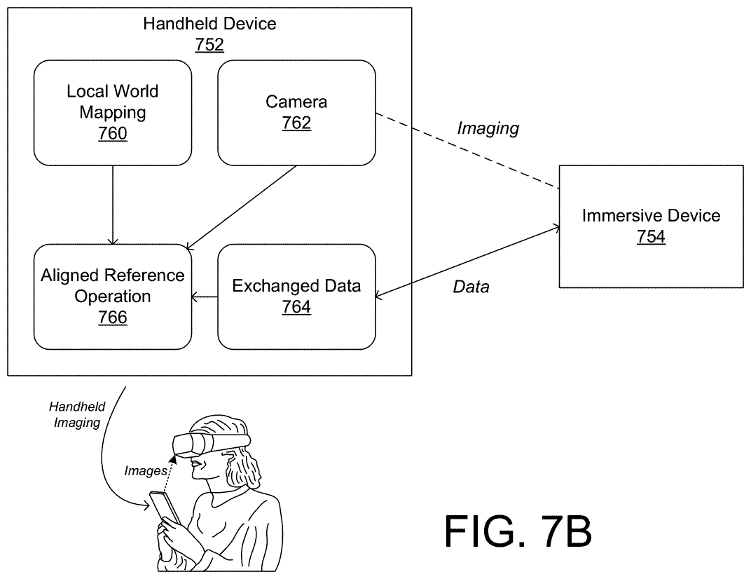

FIG. 7A is an operational scenario of using imaging from a wearable or immersive device to align reference frames with a second device. FIG. 7A includes immersive device 702 and handheld device 704. Immersive device 702 further includes local world mapping 710, camera 712, exchanged data 714, and aligned reference operation 716.

In FIG. 7A, local world mapping 710 is used to provide mapping and spatial recognition for immersive device 702. In some implementations, local world mapping 710 can perform SLAM. SLAM is a technology used in immersive devices like XR headsets to track their position in real-time while simultaneously building a map of the environment. It integrates data from sensors such as cameras, LiDAR, or Inertial Measurement Units to accurately determine the device's location and understand spatial surroundings. In addition to performing SLAM locally at the device, camera 712 performs imaging of handheld device 704 and portions of the user (e.g., arm or other extremity associated with the user). The imaging is used to identify a relationship or orientation of handheld device 704 relative to the portion. In some examples, immersive device 702 can include software that tracks human body motion and posture within an environment. The software integrates data from sensors like cameras, depth sensors, or other components to capture the position and movement of the user's body.

In addition to capturing images including the handheld device 704 and the user (e.g., user's hand), exchanged data 714 is used to provide information from handheld device 704. In some implementations, the information includes orientation data from handheld device 704. The orientation data can include linear acceleration, rotational motion, and magnetic field direction to determine the device's position, tilt, and orientation relative to its surroundings. The orientation data can be collected using sensors like accelerometers, gyroscopes, and magnetometers. In some examples, handheld device 704 will communicate the orientation data in response to the device being in a particular position (e.g., a position associated with the user's hand). In some examples, handheld device 704 will communicate the orientation data in response to a touch input and indicate where the touch input was located on the device.

In some implementations, the image is captured based on the user placing the handheld device 704 in an orientation position (e.g., between the index finger and thumb). In some examples, the user can provide a touch notification indicating that the handheld device 704 has been placed in the orientation position. In some examples, the user can give a voice command indicating that the handheld device 704 is in the orientation position. In response to the device being placed in the orientation position, immersive device 702 can capture an image of handheld device 704 and receive orientation information or data from handheld device 704.

From local world mapping 710, camera 712, and exchanged data 714, immersive device 702 provides aligned reference operation 716 for handheld device 704 with immersive device 702. In some implementations, a calibration parameter is used to adjust a value of rotation along at least one axis. In some examples, aligned reference operation 716 is used to calculate the calibration parameter that adjusts the sensor data from the handheld device based on the imaging data of the portion of the user. In at least one technical solution, the calibration parameter adjusts the orientation information from the handheld device 704 to reflect the orientation information known about the portion. This can include adding or subtracting values associated with any orientation axis for the handheld device 704. This can include adjusting the physical location information provided for the device 704 (e.g., in 3D space). In some examples, the calibration parameter is used to adjust six degrees of freedom. The six degrees of freedom of a device refers to its ability to move and be tracked in three-dimensional space, encompassing three translational movements (forward/backward, up/down, left/right) and three rotational movements (pitch, yaw, roll). As a technical effect, the orientation of the handheld device is adjusted in the common frame based on the observed orientation of the portion of the user.

FIG. 7B illustrates an operational scenario of using imaging from a handheld device to determine a common frame of reference with a wearable or immersive device. FIG. 7B includes handheld device 752 and immersive device 754. Handheld device 752 includes local world mapping 760, camera 762, exchanged data 764, and aligned reference operation 766.

Here, like FIG. 7A, handheld device 752 performs the operations of local world mapping 760, which provides spatial mapping and localization for handheld device 752. In some implementations, local world mapping 760 performs SLAM, which is a technology used in immersive devices like XR headsets to track their position in real-time while simultaneously building a map of the environment. It integrates data from sensors such as cameras, LiDAR, or Inertial Measurement Units to accurately determine the device's location and understand spatial surroundings. Here, camera 762 captures imaging of immersive device 754 and provides the images to aligned reference operation 766, permitting aligned reference operation 766 to determine the calibration parameter to align immersive device 754 in the spatial map for handheld device 752.

In at least one implementation, aligned reference operation 766 uses the captured imaging data and sensor information provided as part of exchanged data 764 to identify and adjust a calibration parameter associated with immersive device 754. In at least one implementation, the device can translate or calibrate the sensor information from immersive device 754 into the common reference frame for handheld device 752. For example, aligned reference operation 766 can use imaging data to determine the orientation of the user's head and compare the orientation calculated from the image to the orientation data provided by immersive device 754. Aligned reference operation 766 can identify a parameter (or parameters) that adjust the orientation data provided from the immersive device to the expected orientation (i.e., determined from the images). As a technical effect, imaging can assist in determining a shared world for the devices by providing an expected orientation and comparing the expected orientation to the orientation data provided by the immersive device.

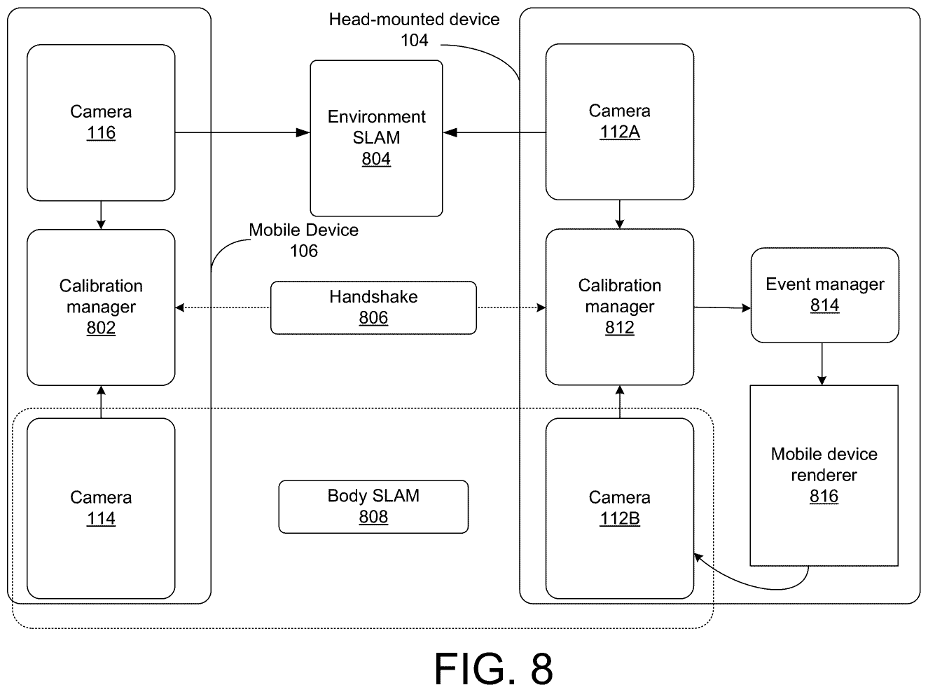

FIG. 8 shows an architecture for aligning one or more devices. The devices to be aligned can include, for example, the mobile device 106 and/or the head-mounted device 104 from FIG. 1A.

The mobile device 106 can include the camera 116 and the camera 114. The camera 114 can capture images of the user 102 (e.g., an inward-facing camera) and the environment and/or objects behind the user 102. The camera 116 can capture images of the environment in front of the user 102 (e.g., an outward-facing camera), such as the object 118. A calibration manager 802 included in the mobile device 106 can integrate objects including the user 102 captured by the cameras 114, 116 to generate a three-dimensional representation of a scene.

The head-mounted device 104 can include an outward-facing camera 112A that captures images of a scene in front of the user 102, and an outward-facing camera 112B that tracks the hand 108 of the user 102. In some examples, the features and/or functions of the cameras 112A, 112B are combined into and/or performed by a single camera such as the camera 112. A calibration manager 812 included in the head-mounted device 104 can integrate objects including the hand 108 and/or mobile device 106 captured by the cameras 112A, 112B to generate a three-dimensional representation of a scene.

The head-mounted device 104 can include an event manager 814. The event manager 814 can respond to events such as the user indicating that the mobile device 106 is aligned with the hand 108 of the user 102, i.e., that the mobile device 106 is in an alignment position 152. Orientation signals from the mobile device 106 may be used to generate the reference frame used to align the SLAM of each device.

The head-mounted device 104 can include a mobile device renderer 816. The mobile device renderer 816 determines a location and/orientation of the mobile device 106 based on motion and/or orientation signals received from the mobile device 106 once a reference frame has been generated.

Based on images captured by the cameras 116, 112A, the mobile device 106 and head-mounted device 104 can perform environmental simultaneous localization and mapping (SLAM) (804). The environmental SLAM can include determining positions and orientations of the mobile device 106 by the head-mounted device 104 and/or determining positions and orientations of the head-mounted device 104 by the mobile device 106.

The calibration manager 802 of the mobile device 106 and the calibration manager 812 of the head-mounted device 104 can engage in a handshake protocol (806). The handshake protocol (806) pairs and/or authenticates the mobile device 106 and the head-mounted device 104 with each other. The pairing and/or authenticating enables the mobile device 106 and head-mounted device 104 to communicate with each other, such as sending sensor data and/or images captured by cameras to each other.

The mobile device 106 and/or head-mounted device 104 can perform body SLAM (808). The body SLAM (808) can include determining locations and/or orientations of the mobile device 106 and/or head-mounted device 104 with respect to each other and/or the surrounding environment.

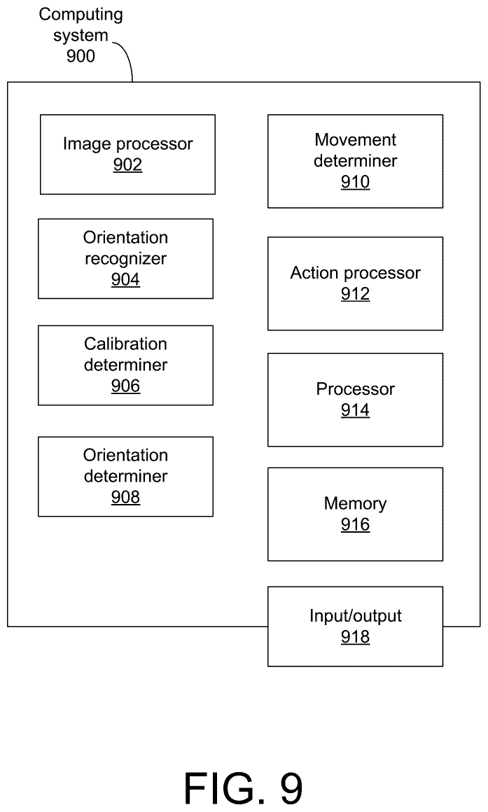

FIG. 9 is a block diagram of a computing system 900 that can implement techniques described herein. The computing system 900 can represent a computing device such as the head-mounted device 104, the mobile device 106, or, in a distributed system, features of the head-mounted device 104 and the mobile device 106.

The computing system 900 can include an image processor 902. The image processor 902 can process images captured by one or more cameras included in the head-mounted device 104 and/or mobile device 106. The image processor 902 can, for example, classify objects, such as body portions including a hand 108 of a user 102 or a face 110 of a user 102, and/or external objects.

The image processor 902 can also generate and/or modify images such as the images 250, 350, 450, 550, 650. The image processor 902 can also generate and/or modify the images by modifying the images captured by the camera, and/or by creating images of objects (such as the objects 510, 610) to project onto a transparent lens of smartglasses within an augmented reality environment. The image processor 902 can, for example, replace the mobile device 106 within the image with a virtual object, such as a sword (object 510) or laser pointer (object 610).

The computing system 900 can include an orientation recognizer 904. The orientation recognizer 904 can recognize orientations of body portions of the user 102. The body portions of the user 102 can be predetermined body parts that the computing system 900 has been trained to classify, recognize, and/or determine locations and/or orientations of. The body portions of the user 102 can include, for example, a face 110 of the user 102 and/or hand 108 of the user 102. The orientation recognizer 904 can recognize the body portion(s) of the user 102, and, upon recognizing the portion, determine a location and/or orientation of the body portion with respect to the computing system 900 (examples of the computing system 900 include the head-mounted device 104 or the mobile device 106).

The computing system 900 can include calibration determiner 906. The calibration determiner 906 can determine a variation and/or difference between the orientation of the portion of the user 102 for which the orientation recognizer 904 recognized the orientation and the other computing device such as the mobile device 106 or head-mounted device 104. The calibration determined 906 can determine a calibration parameter based on the variation and/or difference. The calibration determiner 906 can determine the calibration parameter by comparing (such as performing a subtraction operation on) the recognized location of the portion of the user 102 to the orientation of the other computing device as measured by sensors such as an IMU and/or gyroscope.

The computing system 900 can include an orientation determiner 908. After the computing system 900 has determined the calibration parameter based on the orientations of the other computing device (such as the mobile device 106) and the body portion of the user 102 (such as the hand 108), the orientation determiner 908 can determine the orientation of the other computing device based on the calibration parameter and an orientation of the portion of the user 102 (such as the hand 108) recognized by the orientation recognizer 904. The orientation determiner 908 can add (or subtract) the variation to the recognized orientation of the portion of the user 102 to determine the orientation of the other computing device.

The computing system 900 can include a movement determiner 910. The movement determiner 910 can determine movement of the other computing device, such as the mobile device 106 and/or head-mounted device 104. The movement determiner 910 can determine movement of the other computing device based on locations and/or orientations of the other computing device determined by the orientation determiner 908 and times when the orientations were determined. The movement determiner 910 can determine the movement based, for example, on one or more previous locations of the other computing device and one or more subsequent locations and/or orientations of the other computing device. The movement determiner 910 can, for example, determine a path along which the other computing device moved, such as an arc or a line. The movement determiner 910 can determine a speed at which the other computing device moved along the determined path.

In some examples, the computing system 900 receives movement data from the other computing device. The movement data can include, for example, angular velocity, orientation, and/or acceleration. The movement data can be based on measurements performed by a gyroscope and/or inertial measurement unit (IMU) included in the other computing device. The other computing device can send the movement data to the computing system 900 via a wireless interface. The computing system 900 can determine the movement of the other computing device based on the determined locations and the movement data received from the other computing device.

The computing system 900 can include an action processor 912. The action processor 912 can perform, and/or cause the computing system 900 to perform, actions. The action processor 912 can perform and/or cause the computing system 900 to perform actions based on and/or in response to determined locations and/or movements of the other computing device (such as determined locations and/or movements of the mobile device 106). The actions can include generating visual output (such as text 630) on the display of the head-mounted device 104, making an attack or movement within a game, or input to an application executing on the computing system 900.

The action processor 912 can determine an action to perform based on the determined locations and/or movements by comparing the determined locations and/or movements to gestures stored in a gesture library. The action processor 912 can determine whether the determined locations and/or movements satisfy a correlation threshold with a gesture stored in the gesture library. If the determined locations and/or movements satisfy the correlation threshold with a gesture stored in the gesture library, then the action processor 912 and/or computing system 900 can perform an action associated with the gesture for which the determined locations and/or movements satisfied the correlation threshold.

The computing system 900 can include at least one processor 914. The at least one processor 914 can execute instructions, such as instructions stored in at least one memory device 916, to cause the computing system 900 to perform any combination of methods, functions, and/or techniques described herein.

The computing system 900 can include at least one memory device 916. The at least one memory device 916 can include a non-transitory computer-readable storage medium. The at least one memory device 916 can store data and instructions thereon that, when executed by at least one processor, such as the processor 914, are configured to cause the computing system 900 to perform any combination of methods, functions, and/or techniques described herein. Accordingly, in any of the implementations described herein (even if not explicitly noted in connection with a particular implementation), software (e.g., processing modules, stored instructions) and/or hardware (e.g., processor, memory devices, etc.) associated with, or included in, the computing system 900 can be configured to perform, alone, or in combination with the computing system 900, any combination of methods, functions, and/or techniques described herein. The at least one memory device 916 can include a gesture library. The gesture library can include predetermined gestures. The predetermined gestures can include hand gestures for alignment and movements of a computing device and associated actions.

The computing system 900 may include at least one input/output node 918. The at least one input/output node 918 may receive and/or send data, such as from and/or to, a server, and/or may receive input and provide output from and to a user. The input and output functions may be combined into a single node, or may be divided into separate input and output nodes. The input/output node 918 can include a microphone, a camera (such as a front-facing camera), an IMU, a display, a speaker, a microphone, one or more buttons, and/or one or more wired or wireless interfaces for communicating with other computing devices such as the head-mounted device 104, the mobile device 106, and/or a computing device in communication with the head-mounted device 104 and/or the mobile device 106.

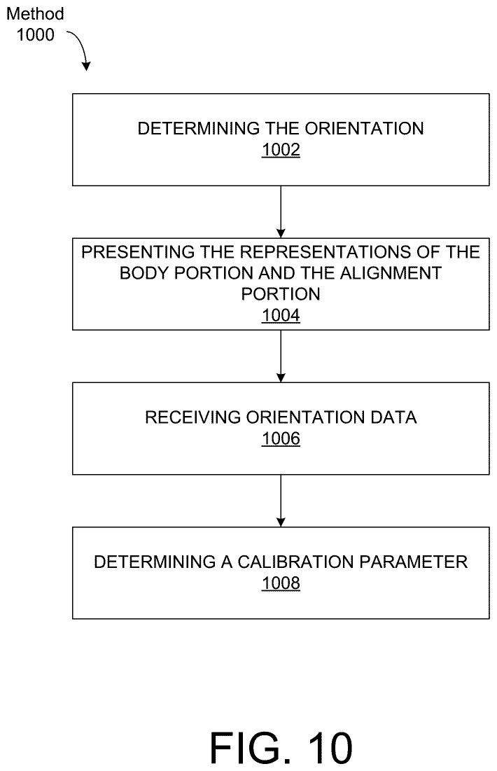

FIG. 10 is a flowchart showing a method 1000 performed by a computing device. The computing device can include the head-mounted device 104 and/or the mobile device 106. The computing device performing the method (such as the head-mounted device 104 or the mobile device 106) can be considered a first computing device. The other of the head-mounted device 104 or the mobile device 106 can be considered a second computing device.

The method 1000 can include determining an orientation (1002). Determining the orientation (1002) can include determining an orientation of a body portion using a camera on the first computing device. The method 1000 can presenting representations of a body portion and an alignment position (1004). Presenting the representations of the body portion and the alignment position (1004) can include presenting, on a display, a representation of the body portion and a representation of an alignment position for a second computing device. The method 1000 can include receiving orientation data (1006). Receiving orientation data (1006) can include, while the second computing device is in the alignment position, receiving a communication from the second computing device, the communication including orientation data. The method 1000 can include determining a calibration parameter (1008). Determining the calibration parameter (1008) can include determining a calibration parameter based on the orientation data and the orientation of the body portion.

In some examples, determining the calibration parameter is performed in response to receiving an indication that the second computing device is in the alignment position.

In some examples, the orientation data indicate an alignment of the second computing device.

In some examples, the method further includes determining an orientation of the second computing device based on a measured orientation of the second computing device and the calibration parameter, the measured orientation being based on sensor measurements performed by the second computing device.

In some examples, the method further comprises performing an action based on a determined orientation of the second computing device.

In some examples, the method further comprises adding writing to a virtual whiteboard based on the orientation of the second computing device.

In some examples, the first computing device includes a head-mounted device, and the second computing device includes a mobile device.

In some examples, the body portion includes a hand.

Examples of systems and methods are provided below. However, other combinations of systems, methods, and operations are possible based on the combinations described herein.

Clause 1. A method performed by a first computing device, the method comprising: determining an orientation of a body portion using a camera on the first computing device; presenting, on a display, a representation of an alignment position for a second computing device relative to the body portion; receiving a communication from the second computing device, the communication including orientation data for the second computing device in the alignment position; and determining a calibration parameter based on the orientation data and the orientation of the body portion, the calibration parameter used to establish a common coordinate system between the first computing device and the second computing device.

Clause 2. The method of clause 1, further comprising: determining at least one additional orientation of the body portion using the camera; receiving at least one additional communication from the second computing device, the at least one additional communication including additional orientation data for the second computing device when the body portion is in the at least one additional orientation; and updating the calibration parameter based on the additional orientation data and the at least one additional orientation of the body portion.

Clause 3. The method of any one of the preceding clauses, further comprising: in response to a touch input to the second computing device, determining an additional orientation of the body portion using the camera; receiving an additional communication from the second computing device, the additional communication including additional orientation data for the second computing device at a time of the touch input; and updating the calibration parameter based on the additional orientation data and the additional orientation.

Clause 4. The method of any one of the preceding clauses, further comprising: determining at least a first location for the first computing device within an environment; receiving second orientation data from the second computing device; and determining at least a second location for the second computing device based on the second orientation data and the calibration parameter.

Clause 5. The method of any one of the preceding clauses, further comprising: determining at least a first orientation for the first computing device within an environment; receiving second orientation data from the second computing device; and determining at least a second orientation for the second computing device based on the second orientation data and the calibration parameter.

Clause 6. The method of any one of the preceding clauses, wherein the calibration parameter comprises a value of rotation along at least one axis.

Clause 7. The method of any one of the preceding clauses, further comprising: presenting, on the display, a representation of the body portion.

Clause 8. The method of any one of the preceding clauses, wherein the body portion comprises an extremity of a user of the first computing device.

Clause 9. A computing system comprising: a computer-readable storage medium; at least one processor operatively coupled to the computer-readable storage medium; and program instructions stored on the computer-readable storage medium that, when executed by the at least one processor, direct the computing system to perform a method for a first computing device, the method comprising: determining an orientation of a body portion using a camera on the first computing device; presenting, on a display, a representation of an alignment position for a second computing device relative to the body portion; receiving a communication from the second computing device, the communication including orientation data for the second computing device in the alignment position; and determining a calibration parameter based on the orientation data and the orientation of the body portion, the calibration parameter used to establish a common coordinate system between the first computing device and the second computing device.

Clause 10. The computing system of clause 9, wherein the method further comprises: determining at least one additional orientation of the body portion using the camera; receiving at least one additional communication from the second computing device, the at least one additional communication including additional orientation data for the second computing device when the body portion is in the at least one additional orientation; and updating the calibration parameter based on the additional orientation data and the at least one additional orientation of the body portion.

Clause 11. The computing system of clause 9 or 10, wherein the method further comprises: determining at least a first location for the first computing device within an environment; receiving second orientation data from the second computing device; and determining at least a second location for the second computing device based on the second orientation data and the calibration parameter.

Clause 12. The computing system of any one of clauses 9 to 11, wherein the method further comprises: determining at least a first orientation for the first computing device within an environment; receiving second orientation data from the second computing device; and determining at least a second orientation for the second computing device based on the second orientation data and the calibration parameter.

Clause 13. The computing system of any one of clauses 9 to 12, wherein the calibration parameter comprises a value of rotation along at least one axis.

Clause 14. The computing system of any one of clauses 9 to 13, wherein the method further comprises: presenting, on the display, a representation of the body portion.

Clause 15. The computing system of any one of clauses 9 to 14, wherein the body portion comprises an extremity of a user of the first computing device.

Clause 16. A computer-readable storage medium having program instructions stored thereon that, when executed by at least one processor, direct the at least one processor to perform a method of operating a first computing device, the method comprising: determining an orientation of a body portion using a camera on the first computing device; receiving a communication from a second computing device, the communication including orientation data for the second computing device at a time the body portion is in the orientation; and determining a calibration parameter based on the orientation data and the orientation of the body portion, the calibration parameter used to establish a common coordinate system between the first computing device and the second computing device.

Clause 17. The computer-readable storage medium of clause 16, wherein the method further comprises: presenting, on a display, an alignment position for the second computing device.

Clause 18. The computer-readable storage medium of clause 16 or 17, wherein determining the orientation of the body portion using the camera on the first computing device comprises: identifying a touch input; and determining the orientation of the body portion in response to the touch input.

Clause 19. The computer-readable storage medium of any one of clauses 16 to 18, wherein the method further comprises: presenting, on a display, a representation of the body portion.

Clause 20. The computer-readable storage medium of any one of clauses 16 to 19, wherein the method further comprises: determining at least a first orientation for the first computing device within an environment; receiving second orientation data from the second computing device; and determining at least a second orientation for the second computing device based on the second orientation data and the calibration parameter.

Clause 21. The computer-readable storage medium of any one of clauses 16 to 20, wherein the calibration parameter comprises a value of rotation along at least one axis.

Clause 22. The computer-readable storage medium of any one of clauses 16-21, wherein the method further comprises: in response to a touch input at the second computing device, determining a second orientation of the body portion using the camera; receiving a second communication from the second computing device, the second communication including second orientation data for the second computing device at a time of the touch input; and updating the calibration parameter based on the second orientation and the second orientation data.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A method performed by a first computing device, the method comprising:
determining an orientation of a body portion using a camera on the first computing device;
presenting, on a display, a representation of an alignment position for a second computing device relative to the body portion;
receiving a communication from the second computing device, the communication including orientation data for the second computing device in the alignment position; and
determining a calibration parameter based on the orientation data and the orientation of the body portion, the calibration parameter used to establish a common coordinate system between the first computing device and the second computing device.

2. The method of claim 1, further comprising:
determining at least one additional orientation of the body portion using the camera;
receiving at least one additional communication from the second computing device, the at least one additional communication including additional orientation data for the second computing device when the body portion is in the at least one additional orientation; and
updating the calibration parameter based on the additional orientation data and the at least one additional orientation of the body portion.

3. The method of claim 1, further comprising:
in response to a touch input to the second computing device, determining an additional orientation of the body portion using the camera;
receiving an additional communication from the second computing device, the additional communication including additional orientation data for the second computing device at a time of the touch input; and
updating the calibration parameter based on the additional orientation data and the additional orientation.

4. The method of claim 1, further comprising:
determining at least a first location for the first computing device within an environment;
receiving second orientation data from the second computing device; and
determining at least a second location for the second computing device based on the second orientation data and the calibration parameter.

5. The method of claim 1, further comprising:
determining at least a first orientation for the first computing device within an environment;
receiving second orientation data from the second computing device; and
determining at least a second orientation for the second computing device based on the second orientation data and the calibration parameter.

6. The method of claim 1, wherein the calibration parameter comprises a value of rotation along at least one axis.

7. The method of claim 1, further comprising:
presenting, on the display, a representation of the body portion.

8. The method of claim 1, wherein the body portion comprises an extremity of a user of the first computing device.

9. A computing system comprising:
a computer-readable storage medium;
at least one processor operatively coupled to the computer-readable storage medium; and
program instructions stored on the computer-readable storage medium that, when executed by the at least one processor, direct the computing system to perform a method for a first computing device, the method comprising:
determining an orientation of a body portion using a camera on the first computing device;
presenting, on a display, a representation of an alignment position for a second computing device relative to the body portion;
receiving a communication from the second computing device, the communication including orientation data for the second computing device in the alignment position; and
determining a calibration parameter based on the orientation data and the orientation of the body portion, the calibration parameter used to establish a common coordinate system between the first computing device and the second computing device.

10. The computing system of claim 9, wherein the method further comprises:
determining at least one additional orientation of the body portion using the camera;
receiving at least one additional communication from the second computing device, the at least one additional communication including additional orientation data for the second computing device when the body portion is in the at least one additional orientation; and
updating the calibration parameter based on the additional orientation data and the at least one additional orientation of the body portion.

11. The computing system of claim 9, wherein the method further comprises:
determining at least a first location for the first computing device within an environment;
receiving second orientation data from the second computing device; and
determining at least a second location for the second computing device based on the second orientation data and the calibration parameter.

12. The computing system of claim 9, wherein the method further comprises:
determining at least a first orientation for the first computing device within an environment;
receiving second orientation data from the second computing device; and
determining at least a second orientation for the second computing device based on the second orientation data and the calibration parameter.

13. The computing system of claim 9, wherein the calibration parameter comprises a value of rotation along at least one axis.

14. The computing system of claim 9, wherein the method further comprises: presenting, on the display, a representation of the body portion.

15. The computing system of claim 9, wherein the body portion comprises an extremity of a user of the first computing device.

16. A computer-readable storage medium having program instructions stored thereon that, when executed by at least one processor, direct the at least one processor to perform a method of operating a first computing device, the method comprising:
determining an orientation of a body portion using a camera on the first computing device;
receiving a communication from a second computing device, the communication including orientation data for the second computing device at a time the body portion is in the orientation; and
determining a calibration parameter based on the orientation data and the orientation of the body portion, the calibration parameter used to establish a common coordinate system between the first computing device and the second computing device.

17. The computer-readable storage medium of claim 16, wherein the method further comprises:
presenting, on a display, an alignment position for the second computing device.

18. The computer-readable storage medium of claim 16, wherein determining the orientation of the body portion using the camera on the first computing device comprises:
identifying a touch input; and
determining the orientation of the body portion in response to the touch input.

19. The computer-readable storage medium of claim 16, wherein the method further comprises:
presenting, on a display, a representation of the body portion.

20. The computer-readable storage medium of claim 16, wherein the method further comprises:
determining at least a first orientation for the first computing device within an environment;
receiving second orientation data from the second computing device; and
determining at least a second orientation for the second computing device based on the second orientation data and the calibration parameter.

21. The computer-readable storage medium of claim 16, wherein the calibration parameter comprises a value of rotation along at least one axis.

22. The computer-readable storage medium of claim 16, wherein the method further comprises:
in response to a touch input at the second computing device, determining a second orientation of the body portion using the camera;
receiving a second communication from the second computing device, the second communication including second orientation data for the second computing device at a time of the touch input; and
updating the calibration parameter based on the second orientation and the second orientation data.
